(19) United States
(12) Patent Application Publication
(10) Pub. No.: US 2017/0330219 A1
(43) Pub. Date: Nov. 16, 2017

(54) COMPETITOR-SPECIFIC BID RECOMMENDATIONS

(71) Applicant: Google Inc., Mountain View, CA (US)

(72) Inventors: Jonathan Ezra Feldman, New York, NY (US); Jeremy Lee Whelchel, Shanghai (CN); Deepti Bhatnagar, Palo Alto, CA (US); Mike Schulman, New York, NY (US); David Vespe, New York, NY (US); Hugh Anthony Lynch, Rocky Hill, NJ (US)

(73) Assignee: Google Inc., Mountain View, CA (US)

(21) Appl. No.: 14/146,468

(22) Filed: Jan. 2, 2014

(51) Int. Cl. G06Q 30/02

(52) U.S. Cl. CPC G06Q 30/0243

(57) ABSTRACT

Systems, methods, and computer-readable storage media that may be used to generate competitor-specific bidding recommendations are provided. One method includes identifying, at a computerized analysis system, at least one competitor of a content provider within a plurality of content auctions for displaying content items. The method further includes calculating, at the analysis system, at least one bidding action estimated to improve performance of the content provider in future content auctions with respect to the at least one competitor from a current level to a goal level of the performance metric. The method further includes providing a recommendation to the content provider to implement the at least one bidding action.

### BACKGROUND

Analysis systems generate various metrics content providers can use to determine the performance of content campaigns (e.g., campaigns to display one or more content items on user devices). For example, analysis systems may provide information about an amount or percentage of impressions the content provider may receive for a particular keyword or keyword group, an average position of selected content items within the keyword/group, and/or other types of metrics. Such metrics may give a content provider a general idea of the performance of its content campaigns, but do not provide any direct feedback on actions the content provider can take to improve performance with respect to particular competitors.

### SUMMARY

One illustrative implementation of the disclosure relates to a method that includes identifying, at a computerized analysis system, at least one competitor of a content provider within a plurality of content auctions for displaying content items. The method further includes determining one or more current bid settings of the content provider. The method further includes determining a current level of a performance metric within the plurality of content auctions for the content provider with respect to a performance of the at least one competitor. The method further includes identifying a goal level of the performance metric for the content provider with respect to the performance of the at least one competitor. The method further includes calculating, at the analysis system, at least one bidding action estimated to improve performance of the content provider in future content auctions with respect to the at least one competitor from the current level to the goal level of the performance metric. The bidding action includes an adjustment to at least one of the one or more current bid settings. The at least one bidding action is calculated based on historical bidding data from the plurality of content auctions for both the content provider and the at least one competitor. The method further includes providing a recommendation to the content provider to implement the at least one bidding action.

Another implementation relates to a system that includes at least one computing device operably coupled to at least one memory and configured to identify at least one competitor of a content provider within a plurality of content auctions for displaying content items. The at least one computing device is further configured to determine one or more current bid settings of the content provider. The at least one computing device is further configured to determine a current level of a performance metric within the plurality of content auctions for the content provider with respect to a performance of the at least one competitor. The at least one computing device is further configured to identify a goal level of the performance metric for the content provider with respect to the performance of the at least one competitor. The at least one computing device is further configured to calculate at least one bidding action estimated to improve performance of the content provider in future content auctions with respect to the at least one competitor from the current level to the goal level of the performance metric. The bidding action includes an adjustment to at least one of the one or more current bid settings. The at least one bidding action is calculated based on historical bidding data from the plurality of content auctions for both the content provider and the at least one competitor. The at least one computing device is further configured to provide a recommendation to the content provider to implement the at least one bidding action.

Yet another implementation relates to one or more computer-readable storage media having instructions stored thereon that, when executed by at least one processor, cause the at least one processor to perform operations. The operations include identifying at least one competitor of a content provider within a plurality of content auctions for displaying content items. The operations further include determining one or more current bid settings of the content provider. The operations further include determining a current level of a performance metric within the plurality of content auctions for the content provider with respect to a performance of the at least one competitor. The operations further include identifying a goal level of the performance metric for the content provider with respect to the performance of the at least one competitor. The operations further include at least one bidding action estimated to improve performance of the content provider in future content auctions with respect to the at least one competitor from the current level to the goal level of the performance metric. The at least one bidding action includes an adjustment to at least one of the one or more current bid settings. The at least one bidding action is calculated based on historical bidding data from the plurality of content auctions for both the content provider and the at least one competitor. The operations further include calculating an estimated cost for implementing the at least one bidding action. The operations further include providing a recommendation to the content provider to implement the at least one bidding action and providing the estimated cost to the content provider. The operations further include determining, based on input from the content provider, whether the content provider has approved the recommendation. The operations further include causing one or more current bids of the content provider to be modified based on the at least one bidding action in response to the input indicating that the content provider has approved the recommendation.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an illustration of a user interface for providing content campaign performance information to a content provider according to an illustrative implementation.

FIG. 2 is an illustration of a user interface for providing content campaign performance information associated with a particular keyword or group of keywords to a content provider according to an illustrative implementation.

FIG. 3 is an illustration of a user interface for providing bid simulation data estimating a change in performance if the content provider changed one or more bid settings according to an illustrative implementation.

FIG. 4 is a block diagram of an analysis system and associated environment according to an illustrative implementation.

FIG. 5 is a flow diagram of a process for generating recommendations for bidding actions configured to improve performance of a content provider with respect to at least one competitor to a goal level according to an illustrative implementation.

FIG. 6 is a Venn diagram showing overlap between impressions of a content provider and impressions of a competitor within a plurality of auctions according to an illustrative implementation.

FIG. 7 is a data flow diagram showing a flow of data used to generate bid action recommendations according to an illustrative implementation.

FIG. 8 is an illustration of a user interface for providing a content provider with recommendations for bid actions to outperform a particular competitor according to an illustrative implementation.

FIG. 9 is an illustration of another user interface for providing a content provider with recommendations for bid actions to outperform a particular competitor in impressions relating to particular keywords according to an illustrative implementation.

FIG. 10 is a block diagram of a computing system according to an illustrative implementation.

### DETAILED DESCRIPTION

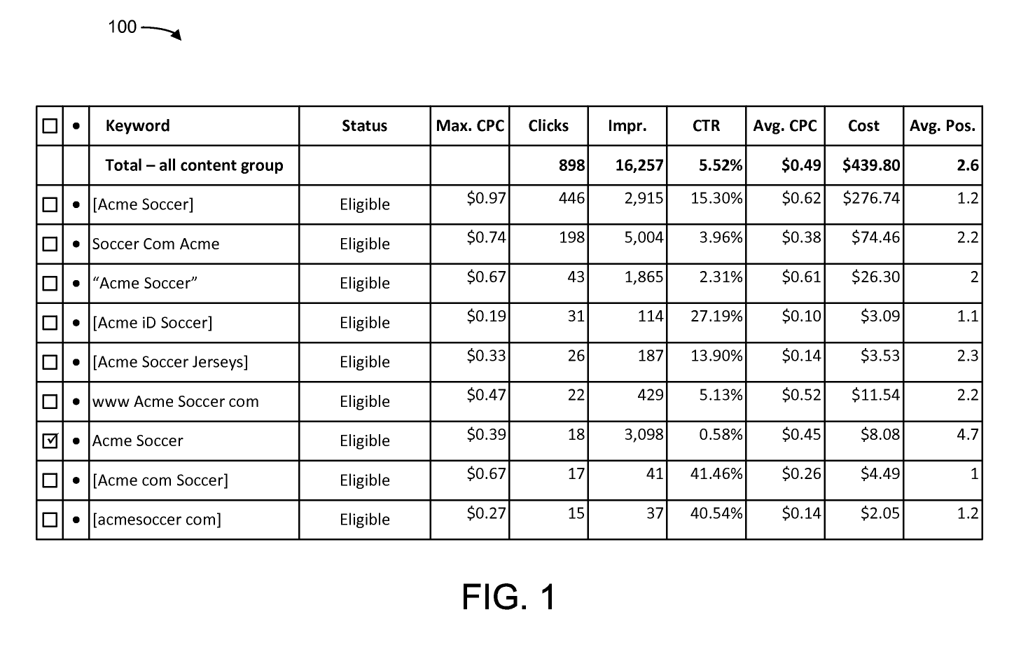

Referring generally to the Figures, various illustrative systems and methods are provided that may be used to generate recommendations for bidding actions that may help content providers perform better with respect to one or more competitors in content auctions. Various types of performance analysis data may be presented to a content provider to assist the content provider in making decisions with respect to its content. For example, FIG. 1 illustrates a user interface 100 configured to display performance data relating to how a content campaign of the content provider has performed within auctions to display content items to users. In the illustrated implementation, the bids of the content campaign are tied to paid keywords. Interface 100 includes information such as a maximum cost per click (CPC) associated with the bid for each of the keywords, a number of impressions shown for each keyword and a number of clicks on the impressions made by users, a click through rate (CTR), an average CPC paid by the content provider, a total cost to the content provider associated with each keyword, and an average position of the impressions within a content interface displayed to the end user.

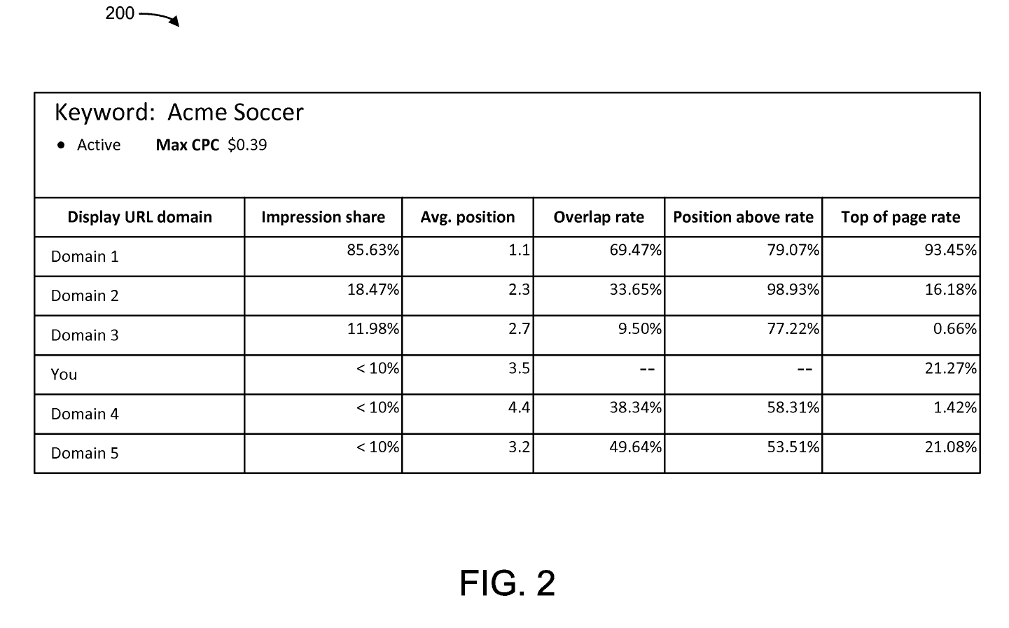

FIG. 2 illustrates another user interface 200 that may provide further details pertaining to one of the keywords or groups of keywords according to an illustrative implementation. In some implementations, interface 200 may be displayed in response to selecting a keyword item in interface 100. Interface 200 may display information pertaining to the performance of both the content provider and one or more competitors. In the illustrated implementation, the competitors are represented and/or aggregated by a domain (e.g., example.com). The data may include information such as an impressions share (e.g., a percentage of impressions received by the content provider/competitor in relation to the content provider and competitors were eligible to receive), average position of impressions within a content interface displayed to an end user, and a rate at which impressions displayed within the content interface were shown within one or more top, or highest priority/exposure, positions. In some implementations, interface 200 may include relative information such as an overlap rate for each competitor (e.g., a percentage of auctions for which the content provider was eligible in which the competitor also participated) and/or a position above rate (e.g., a percentage of auctions where both the competitor and content provider appeared in which the content provider's impressions appeared at a higher position within the content interface than the competitor's impressions).

Both interface 100 and interface 200 provide useful information that the content provider may use to optimize its campaign. However, neither interface give the content provider specific information about how changes in its bidding strategy may affect relative performance outcomes with respect to one or more competitors. For example, using interface 200, the content provider may deduce that a significant increase in a bid value (e.g., max CPC) would be needed to outperform “Domain 1” in impression share, but the content provider may have no idea how much of a bid increase would be required.

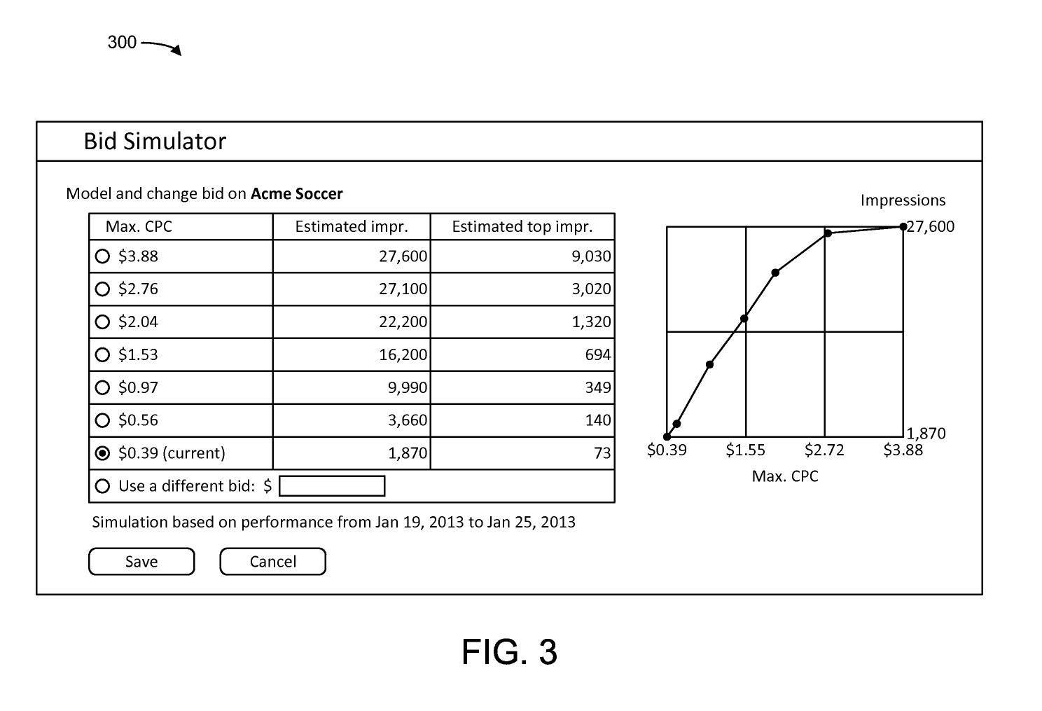

FIG. 3 illustrates a bid simulator interface 300 configured to provide a content provider with estimated information on how certain bid value adjustments may affect particular performance metrics for the content campaign according to an illustrative implementation. Bid simulator interface 300 provides information about different increased bid values and provides an estimate of the number of impressions and number of top impressions (e.g., impressions appearing within one or more top spots within the content interface displayed to end users) that the content provider may receive by adopting the increased bid values. While bid simulator interface 300 gives the content provider an idea of how substantial an impact certain bid increases will make in relation to its current performance, the content provider still does not know what impact such bid adjustments will have on its performance relative to its competitors.

An illustrative analysis system of the present disclosure, in some implementations, may identify one or more specific competitors of a content provider and generate recommendations for improving performance with respect to the competitor(s) on one or more particular metrics. For example, for a particular keyword or keyword group, the analysis system may calculate a bid increase that would cause the content provider to improve performance with respect to an identified competitor in a specific metric. In various implementations, the metric may include a number of impressions (e.g., number of times a content campaign item is selected for display to a user), a percentage or share of impressions (e.g., a number of impressions received versus a number of auctions/queries for which the content campaign was eligible), a winning rate (e.g., a percentage of qualified auctions/queries in which the content provider's campaign outperforms the competitor's campaign), a position above metric (e.g., a metric related to a number of qualified auctions/queries in which the content provider's items appear above the competitor's items), a top of page impression metric (e.g., a number or percentage of qualified auctions/queries in which the content provider's content item impression is placed in a top position or within a set of top positions within a content interface presented to the end user), and/or various other metrics. Recommendations may be provided for a single keyword (e.g., a bidding action recommendation to outperform the competitor on a single keyword), a keyword group (e.g., bidding action recommendations to outperform the competitor on every keyword within a group and/or to outperform the competitor in the aggregate across the keywords), or an entire campaign (e.g., bidding action recommendations to outperform the competitor across the aggregate of all keywords in the campaign). The recommendations may be directed to a single competitor or to multiple competitors.

In some implementations, the analysis system may provide recommendations for the content provider to raise its bids to achieve a particular ranking For example, the analysis system may indicate to the content provider that it currently ranks fifth in impressions share (e.g., number of impressions received versus a number of auctions/queries for which the campaign qualified) for a particular keyword. The analysis system may provide one or more bidding action recommendations that may be performed to improve the rank to a particular position. For example, the content provider may indicate a desire to place second in impression share for the keyword, and the analysis system may recommend one or more bidding actions to pass the current second, third, and fourth place competitors in impressions share for the keyword.

In some implementations, the analysis system may be configured to provide recommendations for the content provider to take bidding actions to improve its relative auction/impression placements with respect to one or more identified competitors. For example, the analysis system may recommend that the content provider increase its bids on one or more keywords to decrease a number or percentage of impressions on which the competitor “outplaced” the content provider and/or increase a number or percentage of impressions on which the content provider “outplaced” the competitor. In some implementations, a competitor may be considered to outplace a content provider in a particular auction when the competitor's campaign is selected by the auction (e.g., such that an impression from the campaign is displayed to a user) and the content provider's campaign is not selected, or when both campaigns are selected, but the competitor's impression appears at a higher, or more prominent, position within the content interface displayed to the user than the content provider's impression.

The systems and methods of the present disclosure may utilize aggregated information pertaining to competitors' bidding strategies when generating and providing information to content providers. However, the underlying specific confidential information about competitors' bidding strategies (e.g., bid values for particular keywords, URLs, etc.) are not revealed, and are kept secret from the content providers. The systems and methods may be configured such that the individualized information cannot be obtained from the aggregated data.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as a city, ZIP code, or state level), so that a particular location of a user cannot be determined. Thus, the user may have control over how information is collected about him or her and used by a content server.

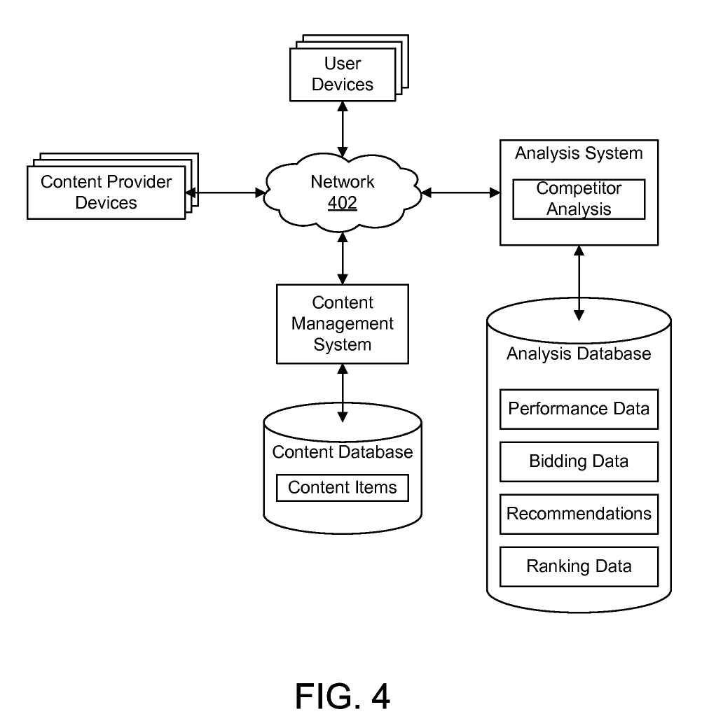

Referring now to FIG. 4, and in brief overview, a block diagram of an analysis system 450 and associated environment 400 is shown according to an illustrative implementation. One or more user devices 404 may be used by a user to perform various actions and/or access various types of content, some of which may be provided over a network 402 (e.g., the Internet, LAN, WAN, etc.). For example, user devices 404 may be used to access websites (e.g., using an internet browser), media files, and/or any other types of content. A content management system 408 may be configured to select content for display to users within resources (e.g., webpages, applications, etc.) and to provide content items 412 from a content database 410 to user devices 404 over network 402 for display within the resources. The content from which content management system 408 selects items may be provided by one or more content providers via network 402 using one or more content provider devices 406.

In some implementations, bids for content to be selected by content management system 408 may be provided to content management system 408 from content providers participating in an auction using devices, such as content provider devices 406, configured to communicate with content management system 408 through network 402. In such implementations, content management system 408 may determine content to be published in one or more content interfaces of resources (e.g., webpages, applications, etc.) shown on user devices 404 based at least in part on the bids.

Analysis system 450 may be configured to analyze performance data for a content provider and at least one competitor of the content provider within content auctions and provide recommendations for improving the content provider's relative performance with respect to the competitor(s). Analysis system 450 may identify at least one competitor of the content provider, such as by receiving a name or other identifier of the competitor from the content provider, by analyzing data from past auctions to determine the competitor based on performance data, or by another method. Analysis system 150 may determine a current level of a performance metric (e.g., an impression share) for the content provider and the competitor. Analysis system 150 may also determine a goal level of the performance metric for the content provider with respect to the competitor. For example, in some implementations, the goal level may be a level (e.g., a minimum level) that outperforms the competitor in the performance metric. In some implementations, the goal level may be an increased ranking position with respect to one or more competitors (e.g., raising an impression share ranking with respect to top competitors for a particular keyword from fifth position to second position).

Analysis system 150 may calculate at least one bidding action (e.g., a bid value increase) estimated to improve the content provider's performance in future content auctions with respect to the competitor to the goal level of the performance metric. Analysis system 150 may calculate the bidding action based on historical bidding data for the content provider and the competitor. In some implementations, analysis system 150 may simulate revised results for each of the relevant previous auctions (e.g., auctions pertaining to a particular keyword/group of keywords being analyzed) occurring over a particular time period, such as the previous week or month, with one or more of various bid adjustments. The results of the auctions may be aggregated to determine estimated new performance metrics associated with adopting the bid adjustments. In some implementations, the estimated new performance metrics may be calculated using aggregated (e.g., average) performance data from the previous auctions without re-simulating each individual auction. Recommendations for one or more bidding actions that the content provider may wish to adopt may be presented to the content provider for consideration.

Referring still to FIG. 4, and in greater detail, user devices 404 and/or content provider devices 406 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 404 may be set-top boxes or other devices for use with a television set. In some implementations, content may be provided via a web-based application and/or an application resident on a user device 404. In some implementations, user devices 404 and/or content provider devices 406 may be designed to use various types of software and/or operating systems. In various illustrative implementations, user devices 404 and/or content provider devices 406 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 404 and/or content provider devices 406 may be configured to receive data from various sources using a network 402. In some implementations, network 402 may comprise a computing network (e.g., LAN, WAN, Internet, etc.) to which user devices 404 and/or content provider device 406 may be connected via any type of network connection (e.g., wired, such as Ethernet, phone line, power line, etc., or wireless, such as WiFi, WiMAX, 3G, 4G, satellite, etc.). In some implementations, network 402 may include a media distribution network, such as cable (e.g., coaxial metal cable), satellite, fiber optic, etc., configured to distribute media programming and/or data content.

Content management system 408 may be configured to conduct a content auction among third-party content providers to determine which third-party content is to be provided to a user device 404. For example, content management system 408 may conduct a real-time content auction in response to a user device 404 requesting first-party content from a content source (e.g., a website, search engine provider, etc.) or executing a first-party application. Content management system 408 may use any number of factors to determine the winner of the auction. For example, the winner of a content auction may be based in part on the third-party content provider's bid and/or a quality score for the third-party provider's content (e.g., a measure of how likely the user of the user device 404 is to click on the content). In other words, the highest bidder is not necessarily the winner of a content auction conducted by content management system 408, in some implementations.

Content management system 408 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 404. In some implementations, the bid amount may be on a cost per impression or cost per thousand impressions (CPM) basis. In further implementations, a bid amount may correspond to a specified action being performed in response to the third-party content being presented at a user device 404. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of user device 404 making a purchase. Such bids are typically referred to as being on a cost per acquisition (CPA) or cost per conversion basis.

A campaign created via content management system 408 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other example parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of a particular online newspaper.

Content management system 408 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 408 may suggest that a third-party content provider increase or decrease their bid amount for desktop devices by a certain percentage, to create a bid amount for mobile devices.

Analysis system 450 may include a competitor analysis module 452 configured to analyze bidding activities of the content provider and one or more competitors and generate recommendations for bidding actions the content provider may adopt to improve its relative performance with respect to the competitors. Competitor analysis module 452 may receive performance data 470 pertaining to the content provider and the competitors and determine a current performance level for one or more performance metrics, such as an impression share, for both the content provider and the competitors. Competitor analysis module 452 may determine one or more goal performance levels, such as a minimum level that is estimated to beat a particular competitor in the performance metric or a level sufficient to achieve a particular ranking (e.g., as reflected in a set of ranking data 476) under the performance metric with respect to one or more competitors. Competitor analysis module 452 may analyze bidding data 472 for the content provider and competitors to calculate a bid value adjustment or other bidding action estimated to achieve the goal performance level. In some implementations, bidding data 472 may be or include historical bidding metrics for previous auctions in which the content provider and competitors participated. Competitor analysis module 452 may generate one or more recommendations 474 for bidding actions that the content provider may wish to adopt, and may present recommendations 474 to the content provider for consideration.

Analysis system 450 may interact with user devices 404, content provider devices 406, content management system 408, and/or various other devices and/or systems to collect data for use in generating recommendations 474. In some implementations, analysis system 450 and content management system 408 may be integrated within a single system (e.g., content management system 408 may be configured to incorporate some or all of the functions/capabilities of analysis system 450).

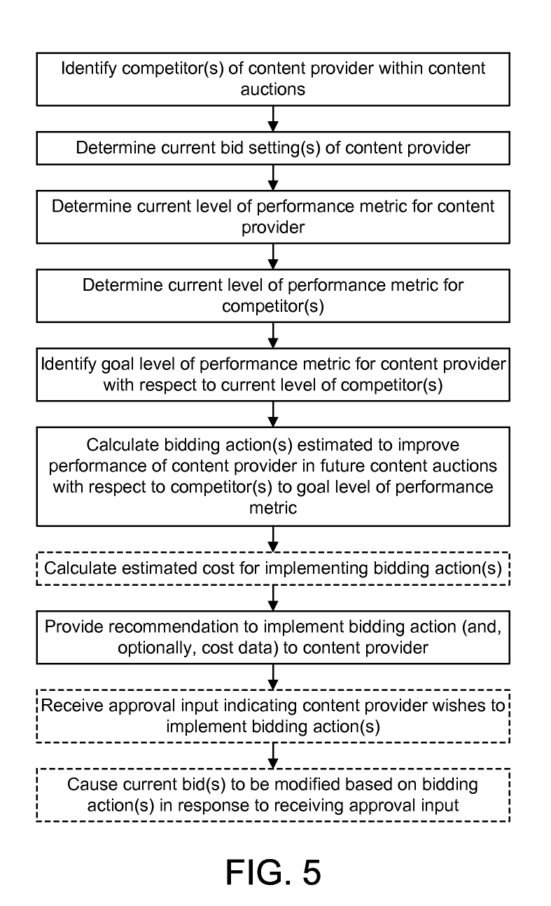

FIG. 5 illustrates a flow diagram of a process 500 for generating recommendations for bidding actions configured to improve performance of a content provider with respect to at least one competitor to a goal level according to an illustrative implementation. Referring to both FIGS. 4 and 5, analysis system 450 may be configured to identify one or more competitors of a content provider within content auctions (505). The identified competitors may be or include the competitors for which the competitive analysis is to be performed. In some implementations, the content provider may provide a list of one or more competitors the content provider wishes to be analyzed.

In some implementations, analysis system 450 may be configured to analyze data from the content auctions (e.g., in an automated fashion) to automatically select and/or provide suggestions for the competitors to be analyzed. In some implementations, the goal may be to identify competitor domains (e.g., competitor URLs) having a performance under a particular performance metric that exceeds that performance of the content provider, and provide bid adjustment suggestions sufficient for the content provider to exceed the performance of the competitor domains. In some implementations, bid suggestions may be provided at a keyword level, for one or more particular paid keywords associated with content bids of the content provider. For a particular (keyword, domain) pair, analysis system 450 may prioritize one or more of the following:
1. High current spend on the keyword (i.e., the content provider cares about the keyword).
2. Large opportunity to gain in the performance metric (i.e., the suggestion makes a material difference to the content provider).
3. High overlap between the content provider and the competitor on the keyword (i.e., the content provider cares about doing better than the competitor, based on the content provider overlapping substantially on the search terms that are most relevant to the content provider).
4. The required bid adjustment, investment, or marginal cost per click is within a particular threshold, so as to be a reasonable change that the content provider may adopt. In some implementations, analysis system 450 may not focus solely on keywords on which the content provider is losing. A main statistic reported on the front end to the content provider may be a number of competing keywords, and a fraction of overall campaign spend that they represent. In some implementations, over all keywords, analysis system 450 may prioritize competitors with high overlap, for example, weighted by spend on the keywords.

In one particular non-limiting, illustrative implementation, competitor domains may be selected as follows. Consider a content provider campaign a and a competitor domain b. The competitor domain b may be scored as

competitor_score(b)=opportunity_score(b)+alpha*summary_score(b)

where opportunity_score is the sum of the spend-weighted, relevance-adjusted keyword opportunities, summary_score is the total spend on overlapping impressions, and alpha is an adjustable weighting coefficient. The opportunity_score for domain b may be defined as

opportunity_score(b)=Σ_{keywords k}opportunity_score(k,b)

where

opportunity_score(k,b)=relevance(k,b)*delta_imps(k,b)*cpi(k)

In the above, relevance(k,b) is a number between 0 and 1 that is defined below, delta_imps(k,b) is the number of impressions the content provider would gain if the suggestion were adopted, and cpi(k) is the current cost per impression the content provider is getting on the keyword k. Thus, opportunity_score(k,b) represents a cost-weighted and relevance-weighted upside for adopting the suggestion. The sum is taken over keywords in which delta_imps is well-defined (e.g., losing keywords that have passed “reasonableness” filters, such as caps on bid ratio, cost ratio, marginal cost per click ratio, etc.).

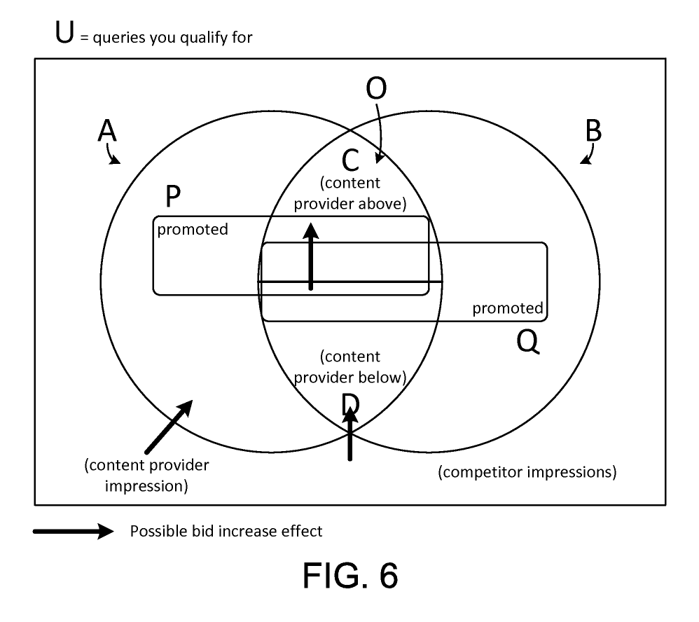

To define relevance(k,b), analysis system 450 may analyze the overlap between the content provider and the competitor domain on the keyword k. FIG. 6 shows a Venn diagram 600 visually representing overlap between a content provider and a competitor for a particular keyword in a plurality of content auctions according to an illustrative implementation. “A” represents queries/auctions where the content provider received an impression, “B” represents queries/auctions where the competitor received an impression, and “O” represents the overlap: queries/auctions where both the content provider and the competitor received an impression. The more B overlaps with A, the more relevant the queries in B-O are likely to be. Venn diagram 600 also includes a box “U” representative of all queries/auctions related to the keyword for which the content campaign of the content provider qualified, a portion “P” illustrating impressions of the content provider that were displayed in a promoted portion of a user interface (e.g., a top position or set of positions in the user interface), and a portion “Q” illustrating impressions of the competitor that were displayed in the promoted portion of the user interface. Area O is divided into a portion “C” for queries/auctions in which the impression of the content provider was displayed in a higher position than the impression of the competitor, and a portion “D” in which the impression of the content provider was displayed in a lower position than that of the competitor.

In some implementations, relevance may be defined as

relevance(k)=|O|/|B|

and may be calculated for each competitor domain and keyword pair as

relevance(k,b)=overlap_rate(k,b)*current_imps(k)/competitor_imps(k,b)

where current_imps is an amount of current impressions for the content provider for keyword k, competitor_imps is an amount of current impressions for the competitor domain b for keyword k, and overlap_rate is defined as follows:

overlap_rate(k,b)=|O|/|A|

The summary_score component of the overall competitor_score may be calculated as

summary_score(b)=Σ_{keywords k}spend_overlap(k,b)

In some implementations, the sum may be taken over all competing keywords, and not just those on which the content provider is losing to the competitor. The spend_overlap may be defined as

spend_overlap(k,b)=current_spend(k)*overlap_rate(k,b)

where current_spend is the current total amount of budget invested by the content provider in keyword k.

In some implementations, competitors may be identified, and recommendations may be provided, at the campaign level. In some implementations, competitors may be identified, and recommendations may be provided, at the keyword level. In still further implementations, competitors may be identified, and recommendations may be provided, at the content provider level. In some such implementations, the scores (e.g., in units of spend) may be summed to obtain content provider level scores, and the top competitors (e.g., the competitors having highest summed competitor scores) may be selected. In some implementations, the data may be represented at a campaign level, such that the competitors with the top N scores at a content provider level are selected, but the data is stored at the campaign level.

In some implementations, analysis system 450 may be configured to give preference to competitors where a Position Above Rate, or a rate at which impressions of the content provider appear above those of a competitor for queries/auctions in which both the content provider and competitor receive impressions, is close to 50%. This may help prevent top competitors from dominating the competitor lists. In some implementations, a Position Above Rate metric may be combined with a metric such as the competitor score described above to select competitors.

In some implementations, competitors may be selected and/or ranked based on “externality” to the content provider, or based on a measure of the total economic impact of the competitors on the content provider. Such a metric may measure or estimate a total amount of economic influence competitors have on the content provider (e.g., based on the competitors' impact on the content provider within the content auctions in combination with external activities of the competitors that have an economic impact on the content provider).

Referring again to FIGS. 4 and 5, analysis system 450 may determine one or more current bid settings of the content provider (510). In some implementations, the current bid settings may include a maximum bid value, such as a maximum cost per click (CPC) or cost per thousand impressions (CPM) bid, for each of the keywords in the campaign(s) being analyzed. In some implementations, the current bid settings may include a bid multiplier, such as a factor by which the bid is multiplied in particular circumstances (e.g., if a quality score, or value representative of the relevance of the content item associated with a bid in an auction to a particular query associated with the auction, exceeds a threshold). In other implementations, the current bid settings may additionally or alternatively include various other settings relating to the values of the bids submitted by the content provider under the campaign(s).

Analysis system 450 may determine a current level of performance under a performance metric for the content provider (515). The performance metric to be analyzed may include any type of quantitative metric representative of an outcome of one or more content auctions. Table 1 is a non-exhaustive list of some illustrative performance metrics that may be utilized according to various implementations, where definitions are provided with reference to Venn diagram 600 shown in FIG. 6. Table 1 further provides an indication of whether each metric is “monotone” in the bid, or is a metric that generally should improve as a bid value is increased (assuming a relatively static number of available queries with increasing bid value).

TABLE 1
ILLUSTRATIVE PERFORMANCE METRICS

| Perfor- | | |
|---|---|---|
| mance | | |
| Metric | Definition | Monotone in Bid? |
| Average | Average position of A vs. average | No. |
| Position | position of B | |
| Overlap | (C + D)/A. Ratio of queries/ | No, because |
| Rate | auctions for which both | denominator |
| | content provider and competitor | is impressions. |
| | received impressions vs. | As bid is increased, |
| | total number of impressions received | total number of |
| | by content provider. | impressions will |
| | | increase as well. |
| Position | C/(C + D). Ratio of queries/auctions | No, because the |
| Above Rate | for which content provider received | denominator is |
| | impression at higher position than | auctions in which |
| | competitor vs. total number of | both content |
| | queries/auctions for which both | provider and |
| | content provider and competitor | competitor appeared. |
| | received impressions. | As bid is raised, |
| | | denominator |
| | | can increase. |
| Top of | P/A (vs. Q/B). Ratio of promoted | No, because |
| Page Rate | impressions (e.g., impressions | denominator is |
| | positioned within one or more top | impressions. |
| | positions in user interface) received | |
| | by content provider to total number of | |
| | impressions received by content | |
| | provider. Compared to corresponding | |
| | ratio for competitor. | |
| Impression | A/U (vs. B/U). Ratio of total number | Yes. |
| Share | of impressions received by content | |
| | provider to total number of | |
| | queries/auctions for which both | |
| | content provider and competitor | |
| | qualified. Compared to corresponding | |
| | ratio for competitor. | |
| “Winning” | (A − D)/U. Ratio of number of | Yes. |
| Rate | queries/auctions in which content | |
| | provider is “winning” compared to | |
| | competitor (e.g., queries/auctions for | |
| | which content provider received | |
| | impression and competitor did not, | |
| | and queries/auctions for which content | |
| | provider received impression at higher | |
| | position than competitor) vs. total | |
| | number of queries/auctions for which | |
| | both content provider and competitor | |
| | qualified. In some implementations, | |
| | calculated as: | |
| | ImpressionShare * (1-OverlapRate * | |
| | (1-PositionAboveRate)) | |
| Position | C/B. Ratio of number of | Yes. |
| Above | queries/auctions for which content | |
| “Share” | provider received impression at | |
| | position above competitor vs total | |
| | number of impressions received by | |
| | competitor. In some implementations, | |
| | calculated as: | |
| | PositionAboveRate * OverlapRate * | |
| | ImpressionShare | |
| Top of | P/U (vs. Q/U). Ratio of number of | Yes. |
| Page | promoted impressions received by | |
| Impression | content provider to total number of | |
| Share | queries/auctions for which both | |
| | content provider and competitor | |
| | qualified. Compared to corresponding | |
| | ratio for competitor. In some | |
| | implementations, calculated as: | |
| | TopOfPageRate * ImpressionShare | |

In some implementations, analysis system 450 may utilize performance metrics that are monotone. Such monotone metrics may be easier to explain and market to content providers, as there is a substantially direct correlation between bid value increases and increases in those metrics.

In various implementations, the universe of queries/auctions (e.g., “U” in diagram 600) may be determined according to different methods. For example, the universe of queries/auctions may include all queries/auctions for which the content provider qualified, all queries/auctions for which both the content provider and the competitor qualified, queries/auctions from curated lists, queries/auctions in a particular category (e.g., shoes), etc. In some implementations, the universe of queries/auctions included in the analysis may be filtered or limited based on various criteria, such as platform (e.g., mobile/desktop), geographic location, time of day, day of week, etc. In some implementations, the universe of queries/auctions included in the analysis may be limited to a particular timeframe, such as the past week or month, the past three weekends or business weeks, etc. In some such implementations, some or all of the criteria used in determining the universe of queries/auctions included in the analysis may be customizable by the content provider.

In some implementations, analysis system 450 may determine a current level of the performance metric for the competitor(s) (520). For example, analysis system 450 may determine a current level of the performance metric for a competitor in the event the performance metric is an individualized metric for the content provider and competitor, such as an impression share (IS) or top of page impression share (TIS). In some implementations, analysis system 450 may not determine a separate current level of the performance metric for the competitor, for example, when the performance metric is a relational metric, such as winning rate or position above share, which by its definition already provides an indication of the relationship between the performance of the content provider and the performance of the competitor.

Analysis system 450 may identify one or more goal levels of the performance metric for the content provider with respect to the performance of the competitor (525). In some implementations, the goal level may be a level that beats the current performance of the competitor. In some implementations, analysis system 450 may determine several goal levels designed to meet particular objectives (beat multiple competitors, beat a competitor by one or more values/percentages, etc.)

In some implementations, analysis system 450 may determine a current ranking of the content provider with respect to the identified competitors, and the goal levels may be one or more target positions within the ranking In some implementations, the user may identify a particular desired target rank with respect to one or more identified competitors. In some implementations, the user may indicate a desire to cut its target rank in half (e.g., from 4^{th} to 2^{nd}), to move up a particular number of spots in the rank (e.g., move up one spot), to move to the top of the ranking, to move to the highest spot that would increase the content provider's spend/CPM/CPC/etc. by a certain level or percentage, accomplish a combination of these goals, and/or accomplish other ranking-related goals. For example, in one implementation, the suggested goal level may be, if the content provider is in 4^{th} or higher position in the ranking, the top ranking, and if the content provider is in a lower position, cutting the position in half.

In some implementations, analysis system 450 may determine the goal levels based on input from the content provider. For example, analysis system 450 may present information to the content provider indicating the current performance of the content provider under the performance metric with respect to the identified competitor(s). Analysis system 450 may provide an interface through which the content provider may identify the goal or goals the content provider wishes to achieve with respect to the competitor(s), and analysis system 450 may calculate the bidding action(s) estimated to achieve the content provider-identified goal(s). In some implementations, analysis system 450 may determine the goal level(s) without intervention from the content provider (e.g., may automatically identify one or more goal levels that may be of interest to the content provider and calculate bidding actions estimated to achieve the goal levels, without first prompting the content provider to identify desired goal levels). The automatically identified goal levels and associated bidding actions may be presented to the content provider, and the content provider may be allowed to select one or more of the bidding actions for implementation. In some implementations, the goals may be tied to a particular timeframe (e.g., the next seven days) or number of future auctions (e.g., the next 100 auctions for a particular keyword or keyword group).

Analysis system 450 may calculate one or more bidding actions estimated to improve performance of the content provider in future content auctions with respect to the competitor(s) from the current level to the goal level of the performance metric (530). The bidding actions may include one or more adjustments to the current bid settings. For example, the bidding actions may include an increase in a bid value (e.g., a maximum cost per click bid), increase in a bid multiplier, adjustment of one or more conditions for applying a bid value increase or multiplier adjustment (e.g., a quality score associated with the application of the bid multiplier), etc. for one or more keywords of the content campaign.

The one or more bidding actions may be calculated based on historical bidding data from the content auctions for the content provider and the competitor(s). The bidding data may be collected by auction system 450, received from content management system 408, provided by content provider devices 406, or collected in some other manner. In some implementations, a bid simulation module may be configured to simulate revised results for a set of auctions (e.g., a set of previously conducted auctions) to estimate bidding actions that would achieve the goal level of the performance metric across the auctions. In some implementations, the auction simulations may be conducted on the assumption that the competitor(s) will adopt the same or similar bid settings as were conducted in previous auctions. In some implementations, the auction simulations may be conducted with one or more simulated bid adjustments (e.g., increases) for the competitor(s). In some implementations, estimated bidding actions may be inferred from aggregated data from the auctions without simulating individual auctions to estimate the bidding actions. In some implementations, analysis system 450 may further calculate one or more estimated outcome values associated with the goal, such as a number or share of impressions expected to be received in response to adopting the bidding action(s).

In some implementations, analysis system 450 may analyze auction logs, and utilize an auction simulation tool to determine a function from a bid to a content interface impression position for each content provider. Analysis system 450 may then use modeling tools to determine how many more or fewer clicks/impressions, and at what cost, are expected in the new simulated position or with the new simulated bid values. The information may be aggregated to build a complete function from bid values to statistics (e.g., clicks, impressions, cost, etc.).

In some implementations, analysis system 450 may calculate an estimated cost for implementing the bidding action(s) (535). The cost may be a cost for individual actions, such as a cost per click (CPC) or cost per thousand impressions (CPM). In some implementations, the cost may be an estimated total cost over a particular time period. For example, if a bidding action of raising a maximum CPC from $2.00 to $2.75 is estimated to generate an additional 9,000 impressions and an additional 200 clicks over a particular time period (e.g., the next week), the estimated cost for implementing the bid increase may be ($0.75*200), or $150.

Analysis system 450 may provide one or more recommendations to implement the bidding action(s), optionally with the estimated cost data, to the content provider (540). The recommendations may be provided to the content provider via an interface provided on a content provider device 406 of the content provider. In some implementations, the recommendation may be transmitted to the content provider device 406, for example, within a data file (e.g., through an email or other data transmission/sharing account of the content provider). In some implementations, the content provider may access an online interface/frontend hosted by analysis system 450 or another system that is configured to provide the recommendation to the content provider and/or allow the content provider to take one or more actions with respect to the recommendation. In various implementations, analysis system 450 may be configured to provide recommendations to any type of content provider, regardless of whether or not they are winning on their keywords. For example, if a content provider ranks first across its campaign, recommendations may be provided to increase the lead of the content provider.

In some implementations, analysis system 450 may be configured to allow the content provider to provide an indication of approval and/or rejection for each recommendation (545). The input may indicate whether or not the content provider wishes to implement the recommended bidding action. If the content provider provides approval input indicating that the content provider wishes to adopt the bidding action, analysis system 450 may be configured to cause the current bid settings of the content provider to be modified based on the bidding action (550). For example, in some implementations, analysis system 450 may directly modify the bid settings for the content provider. In some implementations, analysis system 450 may transmit a command/request to an external system (e.g., content management system 408) configured to cause the external system to modify the bid settings for the content provider.

In various implementations, bidding actions may be calculated and/or recommendations may be provided at the keyword level, the content group (e.g., having multiple keywords) level, and/or at the campaign level. In some implementations in which recommendations are provided at the content group or campaign level, calculations may first be performed at the keyword level, and then aggregated to develop the campaign level recommendations. Using keyword level data in generating the recommendations may help ensure good overlap on the qualified query/auction sets with competitors. At higher aggregation levels, the competitors become disparate, and the resulting performance report may be more likely to rank the content provider in a higher position with respect to competitors, even if the content provider is not ranked highly with respect to its important keywords. For example, consider a content provider joe.com that has a “diapers” and a “toys” content group, each with a single keyword. For the “diapers” content group, competitor diapers.com ranks first with 100 impressions, and joe.com ranks second with 75 impressions. For the “toys” group, competitor toys.com ranks first with 106 impressions, and joe.com ranks second with 80 impressions. If the analysis is performed on the campaign-level data, rather than the keyword-level data, joe.com will rank first with 180 impressions, even though joe.com is second in both content groups. This may be misleading to joe.com, as joe.com may be interested in its ranking in specific markets in which it participates.

In some implementations in which a specific competitor is being analyzed, when aggregating to the campaign level, analysis system 450 may include only keywords in which the competitor meets particular thresholds to ensure that the keywords are relevant to both the competitor and the content provider. For example, analysis system 450 may select keywords for aggregation only if the competitor has a threshold impression share level on the keyword, a threshold overlap rate on the keyword, etc. Once the selected keyword set is identified, analysis system 450 may generate the recommendations. In some implementations, analysis system 450 may take the total aggregate performance metric (e.g., impression share, top of page impression share, etc.) and report to the content provider how well it is doing relative to the competitor. For example, for a keyword set K, where Iₐ is the total impressions for the content provider on K, I_{c} is the total impressions of the competitor on K, and Q is the total qualified queries/auctions over K, then analysis system 450 may report performance metrics of Iₐ/Q vs. I_{c}/Q to the content provider. In some implementations, analysis system 450 may additionally or alternatively report a percentage of keywords on which the content provider is outranking the competitor, or vice-versa. In some implementations, the percentage may be a weighted percentage, for example, by impressions/keyword, top impressions/keyword, spend/keywords, etc.

In some implementations in which recommendations are being provided at a campaign level, recommended bidding actions may include campaign bid scaling multipliers that apply a bid multiplier across all keywords in the campaign. This is simple for content providers to understand, but does not take into account the relative importance of the individual keywords or different levels of competitive opportunity associated with the individual keywords. In some implementations, analysis system 450 may additionally or alternatively select keywords to highlight and provide specific bid recommendations for those keywords. In one implementation, analysis system 450 may assume a uniform keyword-level target rank based on a specific given campaign-level target rank and provide a table of keyword-level bids and cost estimates to achieve that rank for each keyword. The recommendations may be sorted by increase in impressions or top impressions, cost per increase in impressions or top impressions, or another metric. In some implementations, an option may be provided to increase bids on all keywords up to the level required to achieve the target rank. In some implementations, an algorithm, such as a knapsack algorithm, may be used to identify keywords that will most efficiently achieve the campaign-level target rank.

In some implementations, analysis system 450 may be configured to account for a campaign/keyword budget when generating recommendations. For example, if a maximum budget is being approached for a keyword or set of keywords, analysis system 450 may suggest raising the budget, raising both the budget and one or more bids, or lowering bids. In some implementations, analysis system 450 may recommend lowering bids on one or more keywords of lesser importance and/or appearing to have a lesser impact on the performance of the campaign to make room under the budget for recommended increases in bids for one or more other keywords.

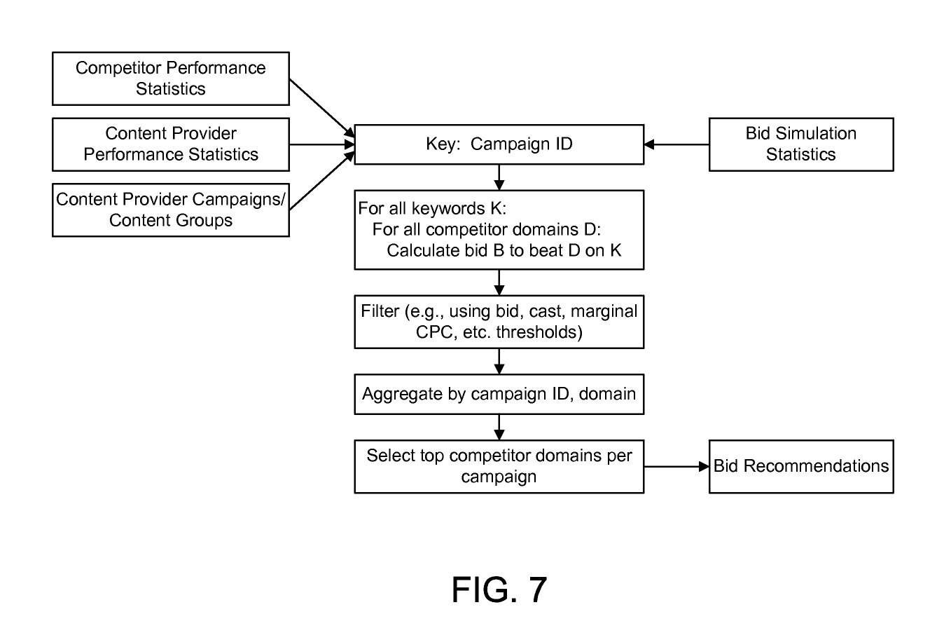

FIG. 7 illustrates a data flow diagram 700 showing data flow and processing operations that may be used to generate bidding action recommendations according to an illustrative implementation. Referring to both FIGS. 4 and 7, analysis system 450 may collect various pieces of information that may be used in combination to analyze the performance of a content provider with respect to one or more competitors and generate the recommendations. Analysis system 450 may collect and/or generate competitor performance statistics 705 relating to one or more performance metrics being analyzed, such as impression share. Analysis system 450 may also collect and/or generate content provider performance statistics 710 containing similar information for the content provider. Analysis system 450 may also receive content provider campaign/content group data 715, which may include information such as keywords within the campaign being analyzed, bid settings (e.g., maximum bid values, bid multipliers, etc.) associated with the keywords, and/or other information pertaining to the campaign. Analysis system 450 may receive bid simulation statistics 720 providing estimated data for different outcomes (e.g., different numbers of impressions/clicks received) if different bid settings were adopted. Some or all of these pieces of data may be accessed and/or tagged by analysis system 450 using a campaign identifier 725.

Analysis system 450 may calculate, for each (keyword, competitor domain) pair, a bid estimated to beat the competitor domain on the keyword under the performance metric (730). In some implementations, analysis system 450 may determine, for a particular keyword and domain, how many of a particular metric (e.g., impressions, clicks, etc.) the domain received based on competitor performance statistics 705. Analysis system 450 may examine bid simulation statistics 720 to determine what bid achieves a level of the metric (e.g., impressions, clicks, etc.) that allows the content provider to achieve a goal level of the performance metric (e.g., a goal impression share, such as a higher impression share than the competitor domain). Analysis system 450 may apply one or more filters to the results, such as bid increase thresholds and/or marginal cost per click thresholds, to eliminate recommendations that would represent an unusually large or unreasonable change in bid settings (740). In some implementations, bid recommendations 750 may be generated on a per-keyword basis and provided to the content provider.

In some implementations, bid recommendations 750 may be generated at a campaign level. In such implementations, analysis system 450 may aggregate the estimated bids calculated using operation 730 by campaign (740). For example, analysis system 450 may aggregate the estimated bid data for all keywords associated with campaign ID 725 with respect to each competitor domain. Once aggregated, the top competitor domains (e.g., the closest competitor domains to the user under the performance metric, the highest-performing domains under the performance metric, etc.) across the keywords of the campaign may be selected, and bid recommendations 750 for achieving desired performance levels may be presented to the content provider.

Analysis system 450 may be configured to generate one or more suggestion cards for providing recommendations at the campaign and/or keyword level. One such campaign-level suggestion card may appear similar to the following:
Suggestions for Campaign: disposable diapers branding
How am I doing?
   You are ranked 4^{th} in top of page (TOP) rate (on average for the campaign)
   You are spending $15k
How can I do better?
We have two suggestions for this campaign:
   1. Raise bids on strategic keywords to improve rank
      10k more top of page impressions (rank: 2^{nd}) for an additional $2k
   2. Apply a campaign bid multiplier of 1.3 to improve rank
      10k more top of page impressions (rank: 2^{nd}) for an additional $1.8k

Another illustrative suggestion view card may appear similar to the following:
Raise bids on strategic keywords to improve top of page impression rank
What is this?
   Keyword: diapers
      1. diapers1.com
      2. diapers2.com
      3. diapers3.com
      4. joe.com
      5. diapers4.com
You are ranked 4^{th} in top of page impression rate on average. This means that, on average, three competitors are getting more impressions at the top of the page than you are (on queries for which you qualify).
What do I get?
10k more top of page impressions, which is estimated to rank this campaign 2^{nd}, for an additional $2k.
   Your campaign has 243 keywords where raising your bid will result in significant gains in top of page impressions. Raising bids for 93 of these keywords will net 10k additional top of page impressions, which is estimated to be sufficient to rank 2^{nd} on average, for a cost of $2k.
   {Alternate} Applying a campaign-wide bid multiplier of 1.3 will net 10k additional top of page impressions for an additional cost of $1.8k

In other views, the content provider may be provided with a visual illustration of its performance, such as a graph illustrating average top of page impression rank for the content provider and/or its competitors over a particular time period.

In some implementations, the content provider may be provided with a summary display of multiple campaigns. One illustrative implementation is shown in Table 2:

TABLE 2
MULTIPLE CAMPAIGN DATA

| | TOP | TOP | | |
|---|---|---|---|---|
| | Impressions | Impressions | | |
| | (rank)- | (rank)- | Cost- | Cost- |
| Campaign | current | estimated | current | estimated |
| diapers- | 40k (4^{th}, top | 50k (2^{nd}) | $15k | $17k |
| branding | competitor- | | | |
| | diapers3.com) | | | |
| wipes- | 13k (3^{rd}, top | 17k (1^{st}) | $4k | $6k |
| branding | competitor- | | | |
| | wipes1.com) | | | |
| toys- | 20k (6^{th}, top | 29k (3^{rd}) | $10k | $20k |
| branding | competitor- | | | |
| | toys.com) | | | |

In the context of a specific campaign, a top-level workflow page may be presented to the user to identify a goal of the user. Such a workflow page may appear similar to the following:
(dropdown menu)
Select Goal:
   (A) Target Rank
   (B) Specific Competitor
(if A:)
(editable field)
Target Rank: [ ]
(if B:)
(dropdown menu)
Select Competitor:
   diapers1.com
   diapers2.com
   diapers3.com

Selecting the different options may result in different sets of keyword-level data being presented to the user. For example, if (A) is selected, the content provider may be presented with a data table similar to that shown in Table 3 (assuming a target rank of 2):

TABLE 3
KEYWORD-LEVEL TARGET RANK DATA

| | | TOP | | |
|---|---|---|---|---|
| | Rank | Impressions | Cost | Bid |
| | (Current -> | (Current -> | (Current -> | (Current -> |
| Keyword | Target) | Estimated) | Estimated) | New) |
| diapers | 3 -> 2 (top: | 35k -> 44k | $12k -> $13.5k | $1.00 -> $1.20 |
| | diapers3.com) | | | |
| nappies | 5 -> 2 (top: | 5k -> 6k | $3k -> $3.5k | $0.80 -> $1.00 |
| | nappies1.com) | | | |
| Total | 3.2 -> 2 | 40k -> 50k | $15k -> $17k | |

If (B) is selected, the content provider may be presented with a data table similar to that shown in Table 4:

TABLE 4
KEYWORD-LEVEL SELECTED COMPETITOR DATA

| | | diapers1.com | | |
|---|---|---|---|---|
| | Top | Top | | |
| | Im- | Impressions | Cost | Bid |
| Key- | pressions | (Your | (Current -> | (Current -> |
| word | (Current) | Target #) | Estimated) | New) |
| diapers | 35k | 37k | $12k -> $12.6k | $1.00 -> $1.05 |
| | (rank: 3^{rd}) | (rank: 2^{nd}) | | |
| nappies | 5k | 6k | $3k -> $3.5k | $0.80 -> $1.00 |
| | (rank: 5^{th}) | (rank: 3^{rd}) | | |
| Total | 40k | 43k | $15k -> $16.1k | |

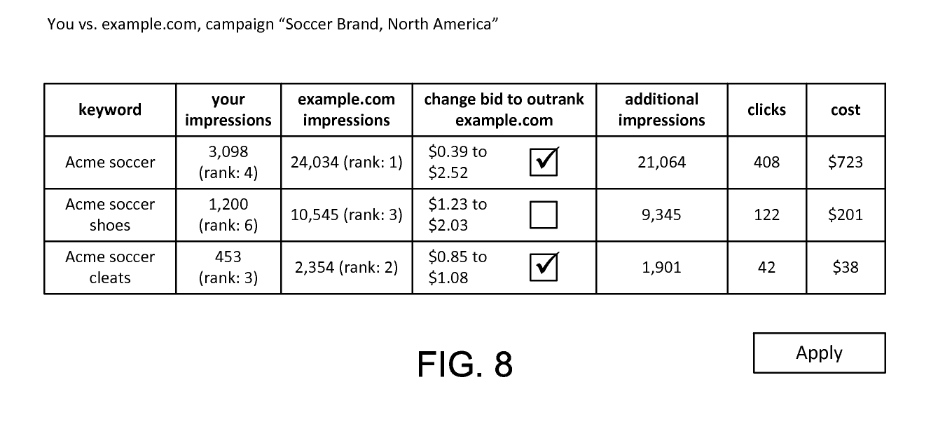

FIG. 8 illustrates a user interface 800 for providing a content provider with recommendations for bidding actions to outperform a particular competitor domain, example.com, according to an illustrative implementation. Interface 800 includes a keyword column 805 that lists different keywords of the content provider's campaign. Interface 800 also includes a content provider impressions column 810 listing a number of impressions received by the content provider over a set of previous content auctions for each keyword and a rank of the content provider with respect to competitors on the keyword based on number of impressions. Competitor impressions column 815 provides similar information for the competitor domain.

Interface 800 also includes a recommendations column 820 configured to provide bid recommendations to the content provider that are estimated to cause the content provider to outrank the competitor domain in future content auctions. For example, for the keyword “Acme soccer,” recommendations column 820 presents a recommendation to increase a maximum CPC bid from $0.39 to $2.52 to outrank example.com on that keyword. Additional impressions column 825 shows an additional number of impressions estimated to be received in the future auctions as a result of the bid increase being implemented. Additional clicks column 830 shows an additional number of user clicks or other content item selections estimated to be gained in the future auctions as a result of the bid increase being implemented. Cost column 835 shows an estimated cost that would be associated with implementing the recommended bid increase. Interface 800 provides approval input boxes 840 through which the content provider may select recommendations that the content provider wishes to approve for implementation. The content provider may select an apply button 845 to transmit the selections to the analysis system.

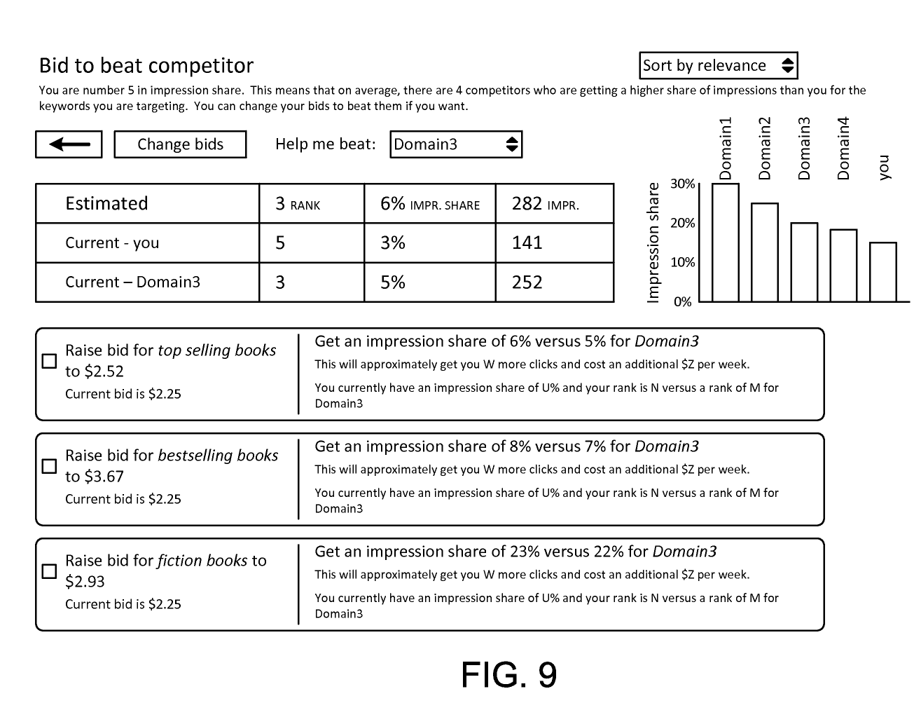

FIG. 9 illustrates another user interface 900 for providing bidding action recommendations to a content provider according to an illustrative implementation. Interface 900 includes a competitor selection input 935 through which the content provider may indicate a competitor for which the content provider would like competitive analysis information/recommendations performed and displayed. A summary field 905 provides a summary of current performance data for the content provider and the selected competitor, including a current rank with respect to a set of identified competitors, a current impression share, and a current number of impressions. Summary field 905 includes an estimated campaign impact field 915 illustrating an estimated effect on the performance of the content provider that is expected to result from implementing the provided recommendations. In some implementations, estimated campaign impact field 915 may be generated based on only those recommendations currently selected in interface 900 by the content provider, and, in other implementations, estimated campaign impact field 915 may be generated based on the assumption that all recommendations are implemented. In some implementations, interface 900 may include a graphical representation 920 of the relative performance of the content provider with respect to the competitor domains. In some implementations, a sorting input 925 may allow the content provider to change how various data items shown in interface 900 are ordered (e.g., by relevance of competitors/keywords to the content provider, by performance level of the competitors, etc.).

Interface 900 may include a keyword detail field 910 for one or more keywords of the content campaign. In some implementations, interface 900 may include a keyword detail field 910 for each keyword in the campaign, and, in other implementations, a keyword detail field 910 may be provided for one or more keywords determined to have a greatest relevance to the content provider. Keyword detail field 910 may include information such as a current bid setting for the keyword, a suggested bidding action/adjustment for the keyword, a current performance value for the content provider in relation to the competitor for the keyword based on previous auctions, an estimated result in future auctions for the keyword if the suggested bidding action is implemented, an estimated cost of implementing the bidding action for the keyword, and/or other types of information. Keyword detail field 910 may also include an approval input configured to allow the content provider to select one or more of the keyword-specific bidding action recommendations for implementation. Once selected, a change bids button 930 may be selected to transmit the selections to the analysis system for implementation.

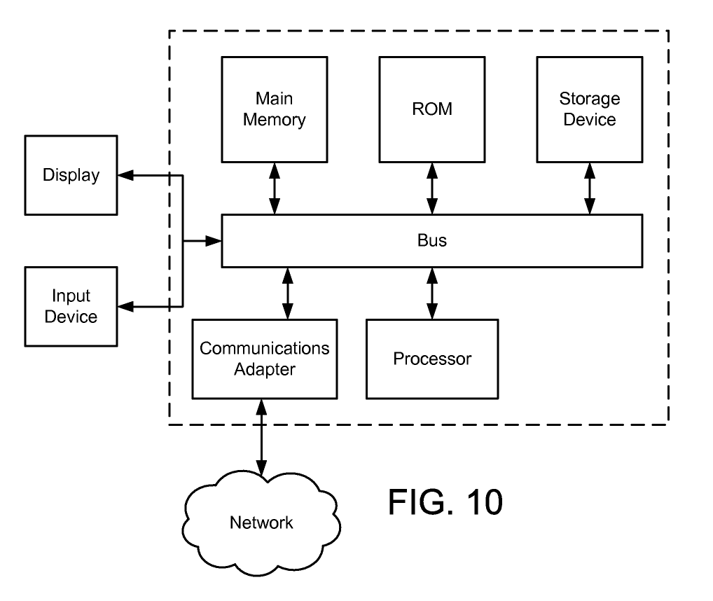

FIG. 10 illustrates a depiction of a computer system 1000 that can be used, for example, to implement an illustrative user device 404, an illustrative content management system 408, an illustrative content provider device 406, an illustrative analysis system 450, and/or various other illustrative systems described in the present disclosure. The computing system 1000 includes a bus 1005 or other communication component for communicating information and a processor 1010 coupled to the bus 1005 for processing information. The computing system 1000 also includes main memory 1015, such as a random access memory (RAM) or other dynamic storage device, coupled to the bus 1005 for storing information, and instructions to be executed by the processor 1010. Main memory 1015 can also be used for storing position information, temporary variables, or other intermediate information during execution of instructions by the processor 1010. The computing system 1000 may further include a read only memory (ROM) 1010 or other static storage device coupled to the bus 1005 for storing static information and instructions for the processor 1010. A storage device 1025, such as a solid state device, magnetic disk or optical disk, is coupled to the bus 1005 for persistently storing information and instructions.

The computing system 1000 may be coupled via the bus 1005 to a display 1035, such as a liquid crystal display, or active matrix display, for displaying information to a user. An input device 1030, such as a keyboard including alphanumeric and other keys, may be coupled to the bus 1005 for communicating information, and command selections to the processor 1010. In another implementation, the input device 1030 has a touch screen display 1035. The input device 1030 can include a cursor control, such as a mouse, a trackball, or cursor direction keys, for communicating direction information and command selections to the processor 1010 and for controlling cursor movement on the display 1035.

In some implementations, the computing system 1000 may include a communications adapter 1040, such as a networking adapter. Communications adapter 1040 may be coupled to bus 1005 and may be configured to enable communications with a computing or communications network 1045 and/or other computing systems. In various illustrative implementations, any type of networking configuration may be achieved using communications adapter 1040, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 1000 in response to the processor 1010 executing an arrangement of instructions contained in main memory 1015. Such instructions can be read into main memory 1015 from another computer-readable medium, such as the storage device 1025. Execution of the arrangement of instructions contained in main memory 1015 causes the computing system 1000 to perform the illustrative processes described herein. One or more processors in a multi-processing arrangement may also be employed to execute the instructions contained in main memory 1015. In alternative implementations, hard-wired circuitry may be used in place of or in combination with software instructions to implement illustrative implementations. Thus, implementations are not limited to any specific combination of hardware circuitry and software.

Although an example processing system has been described in FIG. 10, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
identifying, at a computerized analysis system, at least one competitor of a content provider within a plurality of content auctions for displaying content items;
determining one or more current bid settings of the content provider;
determining a current level of a performance metric within the plurality of content auctions for the content provider with respect to a performance of the at least one competitor;
identifying a goal level of the performance metric for the content provider with respect to the performance of the at least one competitor;
retrieving, from an historical auction database, historical competitor bid data;
retrieving, from the historical auction database, historical content provider bid data comprising one or more content provider bid parameters, and adjusting at least one of the one or more content provider bid data parameters by a bid setting adjustment;
determining a revised outcome of the historical auction based on the historical competitor bid data and the adjusted content provider bid data;
calculating a revised performance metric for the content provider based on the revised outcome;
determining, based on a comparison of the revised performance metric for the content provider to the goal level of the performance metric for the content provider, that the revised performance metric meets or surpasses the goal level;
identifying the bid setting adjustment as a recommended bid setting adjustment responsive to the determination that the revised performance metric meets or surpasses the goal level;
providing a recommendation to the content provider to implement at least one bidding action corresponding to the recommended bid setting adjustment;
receiving approval input indicating that the content provider wishes to implement the at least one bidding action; and
adjusting at least one of the one or more current bid settings based on the at least one bidding action in response to receiving the approval input.

2. The method of claim 1, wherein the performance metric is based on an impression share, wherein the impression share comprises a number of impressions received by the content provider versus an estimated total number of impressions the content publisher was eligible to receive within the plurality of content auctions.

3. The method of claim 2, wherein the performance metric is further based on a percentage of content auctions within the plurality of content auctions for which the content provider received impressions placed in one or more top positions within a content interface.

4. The method of claim 2, wherein the performance metric is further based on a percentage of content auctions within the plurality of content auctions for which impressions received by the content provider appeared above impressions received by the at least one competitor.

5. The method of claim 2, wherein the performance metric is further based on a percentage of content auctions within the plurality of content auctions in which the content provider outperformed the at least one competitor, wherein the analysis system determines the content provider to have outperformed the at least one competitor in a content auction of the plurality of content auctions when at least one of the following is true:
the content provider received an impression in the content auction and the at least one competitor did not receive an impression; or
an impression received by the content provider within the content auction was placed at a higher position in a content interface than an impression received by the at least one competitor.

6. (canceled)

7. The method of claim 1, wherein identifying the at least one competitor of the content provider comprises at least one of:
receiving user input from the content provider specifying a competitor, and identifying the specified competitor as the at least one competitor of the content provider; or
identifying the at least one competitor based on a relative performance of the at least one competitor with respect to the content provider under the performance metric within the plurality of content auctions.

8. The method of claim 1, further comprising:
identifying a ranking of the content provider and the at least one competitor based on a relative performance of the content provider and the at least one competitor under the performance metric within the plurality of content auctions;
wherein the goal level of the performance metric is a goal ranking.

9. The method of claim 1, further comprising:
calculating an estimated cost for implementing the at least one bidding action; and
providing the estimated cost to the content provider along with the recommendation.

10. A system comprising:
at least one computing device operably coupled to at least one memory and configured to:
identify at least one competitor of a content provider within a plurality of content auctions for displaying content items based on a competitor score for the competitor calculated by:
setting a competitor-specific opportunity score to be equal to a combination of (i) a relevance score for one or more keywords based on overlapping impressions, and (ii) a cost per impression score based on a current cost of impressions for the one or more keywords; and
setting the competitor score to be equal to a value proportional to the competitor score, or to a value equal to a combination of a value proportional to the competitor score and at least one other value;
determine one or more current bid settings of the content provider;
determine a current level of a performance metric within the plurality of content auctions for the content provider with respect to a performance of the at least one competitor;
identify a goal level of the performance metric for the content provider with respect to the performance of the at least one competitor;
determine at least one bidding action estimated to improve performance of the content provider in future content auctions with respect to the at least one competitor from the current level to the goal level of the performance metric, wherein the at least one bidding action comprises an adjustment to at least one of the one or more current bid settings, and wherein the at least one bidding action is determined based on historical bidding data from the plurality of content auctions for both the content provider and the at least one competitor;
provide a recommendation to the content provider to implement the at least one bidding action;
receive approval input indicating that the content provider wishes to implement the at least one bidding action; and
adjust at least one of the one or more current bid settings based on the at least one bidding action in response to receiving the approval input.

11. The system of claim 10, wherein the performance metric is based on an impression share, wherein the impression share comprises a number of impressions received by the content provider versus an estimated total number of impressions the content publisher was eligible to receive within the plurality of content auctions.

12. The system of claim 11, wherein the performance metric is further based on a percentage of content auctions within the plurality of content auctions for which the content provider received impressions placed in one or more top positions within a content interface.

13. The system of claim 11, wherein the performance metric is further based on a percentage of content auctions within the plurality of content auctions for which impressions received by the content provider appeared above impressions received by the at least one competitor.

14. The system of claim 11, wherein the performance metric is further based on a percentage of content auctions within the plurality of content auctions in which the content provider outperformed the at least one competitor, wherein the at least one computing device determines the content provider to have outperformed the at least one competitor in a content auction of the plurality of content auctions when at least one of the following is true:
the content provider received an impression in the content auction and the at least one competitor did not receive an impression; or
an impression received by the content provider within the content auction was placed at a higher position in a content interface than an impression received by the at least one competitor.

15. The system of claim 10, wherein the at least one computing device is configured to:
identify a ranking of the content provider based on a relative performance of the content provider and the at least one competitor under the performance metric within the plurality of content auctions; and
determine the at least one bidding action by determining one or more bid increases estimated to move the content provider to an identified higher position within the ranking in the future content auctions.

16. The system of claim 10, wherein setting the competitor score comprises setting the competitor score to be equal to a combination of (i) the opportunity score and (ii) a summary score that is based on a total spend on overlapping impressions.

17. One or more computer-readable storage media having instructions stored thereon that, when executed by at least one processor, cause the at least one processor to perform operations comprising:
identifying at least one competitor of a content provider within a plurality of content auctions for displaying content items;
determining one or more current bid settings of the content provider;
determining a current level of a performance metric within the plurality of content auctions for the content provider with respect to a performance of the at least one competitor;
identifying a goal level of the performance metric for the content provider with respect to the performance of the at least one competitor;
retrieving, from an historical auction database, historical competitor bid data;
retrieving, from the historical auction database, historical content provider bid data comprising one or more content provider bid parameters, and adjusting at least one of the one or more content provider bid data parameters by a bid setting adjustment;
determining a revised outcome of the historical auction based on the historical competitor bid data and the adjusted content provider bid data;
calculating a revised performance metric for the content provider based on the revised outcome;
determining, based on a comparison of the revised performance metric for the content provider to the goal level of the performance metric for the content provider, that the revised performance metric meets or surpasses the goal level;
identifying the bid setting adjustment as a recommended bid setting adjustment responsive to the determination that the revised performance metric meets or surpasses the goal level;
calculating an estimated cost for implementing the at least one bidding action;
providing a recommendation to the content provider to implement at least one bidding action corresponding to the recommended bid setting adjustment;
providing the estimated cost to the content provider;
determining, based on input from the content provider, whether the content provider has approved the recommendation; and
causing the one or more current bid settings to be modified based on the at least one bidding action in response to the input indicating that the content provider has approved the recommendation.

18. The one or more computer-readable storage media of claim 17, wherein the performance metric is based on an impression share, wherein the impression share comprises a number of impressions received by the content provider versus an estimated total number of impressions the content publisher was eligible to receive within the plurality of content auctions.

19. The one or more computer-readable storage media of claim 18, wherein the performance metric is further based on at least one of the following:
a percentage of content auctions within the plurality of content auctions for which the content provider received impressions placed in one or more top positions within a content interface;
a percentage of content auctions within the plurality of content auctions for which impressions received by the content provider appeared above impressions received by the at least one competitor; or
a percentage of content auctions within the plurality of content auctions in which the content provider outperformed the at least one competitor, wherein the instructions cause the at least one processor to determine the content provider to have outperformed the at least one competitor in a content auction of the plurality of content auctions when at least one of the following is true:
the content provider received an impression in the content auction and the at least one competitor did not receive an impression; or
an impression received by the content provider within the content auction was placed at a higher position in the content interface than an impression received by the at least one competitor.

20. The one or more computer-readable storage media of claim 17, wherein the operations further comprise:
identifying a ranking of the content provider and the at least one competitor based on a relative performance of the content provider and the at least one competitor under the performance metric within the plurality of content auctions
wherein the goal level of the performance metric is a goal ranking.
